(19) United States
(12) Patent Application Publication
(10) Pub. No.: US 2004/0064825 A1
(43) Pub. Date: Apr. 1, 2004

(54) Method and system for object system interoperability

(76) Inventors: Timothy Lim, New York, NY (US); Peter Sumner, London (GB); Ian Stone, London (GB)

Correspondence Address: MILBANK, TWEED, HADLEY & MCCLOY LLP, 1 CHASE MANHATTAN PLAZA, NEW YORK, NY, 10005-1413, US

(21) Appl. No.: 10/261,256

(22) Filed: Sep. 30, 2002

(51) Int. Cl. G06F 13/00

(52) U.S. Cl. 719/319; 715/513

(57) ABSTRACT

A system and method for object system interoperability is provided. The system comprises an object generator, a target program, and a formatter which is a serializer and/or deserializer. The method comprises the steps of executing the object generator, which uses a data model specification to generate self-reflective object classes in the target program, which in turn calls a formatter to translate between an object instance and serial data.

This application contains two (2) identical compact discs (CD-ROMs) each containing a Computer Program Listing Appendix for the above-captioned application. The contents of the Computer Program Listing Appendix are incorporated herein by reference. The discs are in IBM-PC machine format and are MS-Windows operating system compatible. The files on each disc are named “Msg.cpp”, “Msg.hpp” and “Msg java”, are 8, 11 and 14 KB in size, respectively, and were each created on Sep. 27, 2002.

### BACKGROUND

1. Field of the Invention

The present invention has application generally to computer programming where data must be transferred across programs, where at least one of the programs is written in an object oriented programming language such as C++, Java, Visual Basic, Smalltalk, etc. It is particularly useful where the programs are written in different languages. It is also particularly useful where data must be transferred between programs on two different operating systems, where at least one of the programs is based on object oriented programming language.

2. Description of the Related Art

When a programmer is developing an object oriented programming application that needs to communicate with at least one other application, the programmer often needs to translate data between the “object” form in his application and a data form which can be understood by the other application. This is particularly an issue when using one programming language and operating system, and the application needs to communicate with at least one other application which uses a different programming language or operating system.

The term “object” as used herein means a single run-time instance of an object class, which is often just called a class. An object class can be viewed as a blueprint from which many objects can be formed. See U.S. Pat. No. 6,373,950, issued Apr. 16, 2002 to Rowney, incorporated herein by reference. An object may contain data. An “object” is also known as an “object instance” because it is an embodiment or “instantiation” of an object class. Instances of a single class are differentiated from one another by their attribute values, but not their structure, procedures or routines. See U.S. Pat. No. 6,199,195, issued Mar. 6, 2001 to Goodwin et al., incorporated herein by reference.

An “object-oriented program” (OOP) is a program which uses a set of object instances that work in cooperation to perform useful work. Object oriented programming has been increasingly used to develop complex applications. Programming languages that use OOP include JAVA, C++, Smalltalk, common lisp object system (CLOS), and Eiffel. Additionally, OOP capabilities are being added to more traditional popular computer programming languages such as Pascal and Basic (e.g., Microsoft Visual Basic uses OOP).

The difference between procedural programming and an object oriented program is that through its structure and procedures, an object “knows” what operations can be performed on its data, whereas procedural programs generally do not have the semantics that define relationships and functions of the data. There are exceptions in the sense that object-like behavior has been achieved in some procedural programming languages, for example. Otherwise, however, it is up to the developer to know about these relationships, what they mean, and how to handle them.

Object-oriented programs effectively define an architecture specification, or object model, which enables all object classes defined in the program to work together. Thus, such an object model is a set of semantic elements which define object classes, their interrelationships, and inheritance between object classes.

Object oriented programming has a number of valuable benefits. For example, it enables software developers to build objects out of libraries of reusable classes. Thus, a new software program may consist of, for example, 90% proven components made from preexisting reusable object classes, and only 10% of new software written and tested from scratch. Since the 90% already came from an inventory of extensively tested reusable object classes, the potential domain from which an error could originate is 10% of the program.

Object oriented programming also allows programmers to specify aggregation and association relations (hereinafter “relations”) between classes. An aggregation is a hierarchy or tree relation wherein a class is made up of constituent classes or members; an association declares a connection (link) between classes by using references or pointers to other classes.

Subclassing, polymorphism and encapsulation are also valuable attributes of OOP. Subclassing allows the programmer to create an object class that inherits and/or extends the properties and methods from another object class. Specifically, one object class may be derived from another class and “inherit” its properties and methods but add further limitations, capabilities, or detail, or override specific functions, for example. The class with the additional limitations, capabilities or detail is a “subclass” of the parent or “base” class. Because subclassing or inheritance makes it possible to make new classes that extend and modify classes available in the system, new capabilities are created without having to start from scratch.

In addition to overriding specific functions of the base class, a subclass may skip over base functions and use new functions related to the subclass. To access a new function, a programmer could call the same function with the same name, but the subclass may have a different, overriding implementation behind the same name. This ability have different implementations of a function behind the same name is called polymorphism. Similarly, object oriented program allows encapsulation, which is data or implementation hiding.

A problem often arises when developing an application in an object oriented programming language and data is therefore embodied in object instances. Specifically, some accommodation is usually required in order to share data with another application. This is true generally, but particularly when the other application uses a different language or operating system. For example, a programmer developing an application in C++ may need to find some means to correlate and/or share data between a C++ object instance and a corresponding object class or instance in Visual Basic. The same applies if the languages are the same, but the operating systems are different, e.g., one being Windows and other being Unix. Whether due to differences in the programming languages or in the operating systems, such different object systems usually do not work directly together for a number of reasons. There may be, for example, incompatibilities due to differences in how the object systems create objects, call methods, and set properties, in turn reflecting differences in fundamental mechanisms or in low-level calling conventions or representations of data. In addition, various object systems also support various types which may not be compatible with other object systems. Simple examples of types include types such as integers, floats, etc. More complex types include arrays, and objects.

Thus, especially when the programs are written in different languages or operating systems, implementing a correspondence between data structures can be burdensome because it often requires any given programmer to have knowledge of both languages or operating systems. Even if the programmer has expertise in both languages or operating systems, it nevertheless would be helpful to have an efficient way to implement correspondence and sharing between data structures.

There are a number of patents or products available for creating the ability to access and use objects from different object systems, or for mapping objects to procedural programming systems or to relational databases. Such patents and products are helpful because different systems are best suited to different tasks.

One system and method of interest is U.S. Pat. No. 5,732,270, issued Mar. 24, 1998, and U.S. Pat. No. 6,349,343, issued Feb. 19, 2002, both to Foody et al., for a “System and method for providing interoperability among heterogeneous object systems.” Foody describes by way of background three solutions for providing interoperability among various object systems: stub function wrappers; a common wire protocol; and dynamic converters. The description from Foody and the references cited therein are incorporated herein by reference.

Foody discloses a system and method to enable objects from two or more heterogeneous object systems to interoperate. Objects from a foreign object system appear to be native to the object system in which they are used or accessed. A native proxy object that is indistinguishable from other native objects is constructed for the real foreign object. The proxy object contains an identifier to the real foreign object, as well as a pointer to a software description of how to access and manipulate the object, e.g., how to call its methods, set its properties, and handle exceptions. When the proxy object is manipulated, it follows the instructions in the software description, which in turn results in the corresponding manipulation of the foreign object.

Other patents of interest include U.S. Pat. No. 6,373,950, issued Apr. 16, 2002 to Rowney, and U.S. Pat. No. 6,199,195, issued Mar. 6, 2001 to Goodwin et al.

At least one version of Java Message Service (JMS), which is used for Java programming, is also of interest. In one aspect, JMS allows data in a data interchange format to be populated into a generic JMS Java object, which then can be queried to populate specific Java objects of interest to the programmer. In another aspect, a programmer can take data from specific Java objects and populate the generic JMS object, and then JMS can be used to automatically generate a message in the data interchange format. See http://java.sun.com/products/jms/. The generic Java object class is defined by an API provided by JMS. Although the generic class can be populated with and queried for data values, the task of querying can be burdensome and prone to error, and typically requires the foreknowledge of somewhat low-level detail regarding the data structure, types, etc.

Also of interest is the WC3 Document Object Model (DOM), which creates among other things another means for programmers to convert data between object form and data interchange format. DOM is a platform and language-neutral interface to allow programs and scripts to dynamically access and update the content of a document, which is typically in XML or HTML. In one aspect, a programmer provides a document containing structured data to the DOM API, which in turn populates a generic DOM object in the language and platform of choice (provided that the DOM is supported). The generic DOM object then can be queried for specific data values. Conversely, programmers can write to the standard DOM objects, and the DOM API can then in turn automatically generate a DOM document. Thus, DOM helps to increase interoperability with other programs and on the Web. See http://www.w3.org/DOM/ (specification main page), and http://xml.coverpages.org/dom.html#intro, which are both incorporated herein by reference. As with JMS, querying and processing the generic object can be burdensome and prone to error. In addition, because the DOM generally treats data as text without associated data types, the object elements typically must be interpreted upon querying and processing the generic DOM object and/or using it to populate specific objects.

Also of interest is “Java Architecture for XML Binding” (JAXB), which offers simple code generation by compiling a “Document Type Description” (DTD) into one or more Java object classes. A DTD is a form of data model specification that provides a higher level of abstraction to marked-up documents than markup alone. A data package (e.g., message or document) or object class that corresponds to a data model specification is referred to herein as a data model-specified or “DMS” class or data package.

Generally, markup alone describes a document's structure and content, and assigns names to the data. A well formed XML document without a data model specification such as a DTD can have any number of element names in any order, appearing with any kind of frequency. There is generally no description of the relations between elements, other than the order in which the elements appear and some local hierarchy through local nesting. DTDs provide a higher level of abstraction by defining the relations of data elements within a document.

However, DTD provides no standard or conventional way of specifying data types and inheritance relationships. XML Schema goes further by providing a standardized way of specifying data types and also providing for a possibility of inheritance. Thus, although schemas generally can specify any structure or relationship that can by specified by DTDs, schemas are generally a richer and more powerful way of describing information than what is possible with DTDs alone.

Sun Microsystems describes JAXB at the website http://java.sun.com/xml/jaxb/. As described on the website, JAXB compiles DTDs into Java DMS classes that handle XML parsing and formatting. To support data typing, JAXB relies on separate XML binding schema to provide the data type information not contained in the DTDs. An example of a DTD and an associated binding schema from the JAXB user manual is shown in Table 1. The DMS classes also perform validation to ensure that the constraints expressed in the DTDs are enforced in the resulting methods and Java data types. While JAXB works for converting data between Java objects and XML data interchange format, it does not currently have applicability to other programming languages and data interchange formats. In addition, although SUN Microsystems states on its website that its JAXB group is working on support for a subset of XML Schema and XML namespaces, the website also indicates that currently only DTDs are supported.

TABLE 1

| | |
|---|---|
| The DTD: checkbook.dtd | The Binding Schema: checkbook.xjs |
| <!ELEMENT checkbook ( transactions, balance ) > | <?xml version=“1.0” encoding=“ISO-8859-1” ?> |
| <!ELEMENT transactions ( deposit \| check \| withdrawal )* > | <xml-java-binding-schema version=“1 Oea”> |
| <!ELEMENT deposit ( date, name, amount )> | <element name=“checkbook” type=“class” root=“true” /> |
| <!ATTLIST deposit | <element name=“transactions” type=“class” root=“true”> |
| category ( salary \| interest-income \| other ) #IMPLIED > | <content> |
| <!ELEMENT check (date, name, amount, ( pending \| void \| cleared ), | <choice property=“entries” collection=“list” supertype=“Entry” /> |
| memo? ) | </content> |
| > | </element> |
| <!ATTLIST check | <element name=“balance” type=“value” convert=“BigDecimal”/> |
| number CDATA #REQUIRED | <element name=“amount” type=“value” convert=“BigDecimal” /> |
| category ( rent \| groceries \| other ) #IMPLIED > | <element name=“date” type=“value” convert=“TransDate” /> |
| <!ELEMENT withdrawal ( date, amount ) > | <element name=“deposit” type=“class” > |
| <!ELEMENT balance (#PCDATA) > | <attribute name=“category” convert=”DepCategory” /> |
| <!ELEMENT date (#PCDATA ) > | </element> |
| <!ELEMENT name (#PCDATA) > | <element name=“check” type=“class” > |
| <!ELEMENT amount (#PCDATA) > | <content> |
| <!ELEMENT memo (#PCDATA) > | <element-ref name=“date”/> |
| <!ELEMENT pending EMPTY > | <element-ref name=“name” /> |
| <!ELEMENT void EMPTY > | <element-ref name=“amount” /> |
| <!ELEMENT cleared EMPTY > | <choice property=“pend-void-clrd”/> |
| | </content> |
| | <attribute name=“number” convert=“int” /> |
| | <attribute name=“category” convert=“CheckCategory” /> |
| | </element> |
| | <conversion name=“BigDecimal” type=“java.math.BigDecimal” /> |
| | <conversion name=“TransDate” type=“java.util.Date” |
| | parse=“TransDate.parseDate” print=“TransDate printDate” /> |
| | <enumeration name=“DepCategory” members=“salary interest- |
| | income other”/> |
| | <enumeration name=“CheckCategory” members=“rent groceries |
| | other”/> |
| | <interface name=“Entry” members=“Deposit Check Withdrawal” |
| | properties=“date amount” /> |
| | </xml-java-binding-schema> |

Another system called “Castor” offers code generation from XML Schema, but does not perform any validation of the data. See http://castor.exolab.org/. Here again, the system currently works only for Java programs and for the XML data interchange format, and it does not provide for validation.

The preceding description is not to be construed as representing that any of the foregoing is necessarily prior art relative to the present invention. Nor is it necessarily an exhaustive description or analysis. Any figure labeled “prior art” is labeled as such only to ensure that patent printers do not confuse it with drawings of the claimed invention.

### SUMMARY OF THE INVENTION

In one embodiment, the invention provides a method and system for providing interoperability among various object systems. According to a preferred embodiment, the invention is a method which includes providing a data model specification to an object generator, executing the object generator to generate code comprising a DMS object class with at least one self-reflection function, and executing a program which in turn executes a formatter which is separate from the object class, whereby the formatter translates between at least one DMS object instance and at least one DMS serial data package.

According to another preferred embodiment, the invention is a system comprising an object-oriented program, an object generator capable of using a data model specification to generate code comprising a DMS object class with at least one self-reflection function, a DMS object class created by the object generator, and a formatter which is separate from the DMS object class and is capable of using information from the self-reflection function to translate between a DMS object instance and a DMS serial data package.

According to another preferred embodiment, the invention is computer executable software code which includes a data model specification, code to use the data model specification to generate code comprising a DMS object class with at least one self-reflection function, code comprising the DMS object class, and code to separate from the DMS object class to translate between a DMS object instance and a DMS serial data package, using information from the self-reflection function.

According to another preferred embodiment, the invention is a programmed computer that includes memory having at least one region for storing code and a processor for executing code stored in the memory, wherein the memory is programmed with code comprising a data model specification, the processor is programmed to use the data model specification to generate code comprising a DMS object class with at least one self-reflection function, the memory is programmed with code comprising the DMS object class, and the processor is programmed to separate from the DMS object class to translate between a DMS object instance and a DMS serial data package, using information from the self-reflection function.

According to a preferred embodiment, the invention is a method which includes normalizing a data model specification and determining whether there is a data model specification element to process. If there is a data model specification element to process, then it is determined whether the element is a simple type, a complex type, or an array. If it is a simple type, then a routine or step is executed for generating a simple type DMS object class comprising a self-reflection function. If the element is a complex type or array, then a routine or step is executed for generating a complex type or array DMS object class comprising a self-reflection function. Control is then transferred back to the step of determining whether there is a data model specification element to process. The self-reflection function of the DMS object class generated according to the method of the present invention is capable of providing sufficient information to allow a formatter separate from the DMS object class to translate between at least one DMS object instance and at least one DMS serial data package.

### BRIEF DESCRIPTION OF THE DRAWINGS

Features and aspects of certain preferred embodiments of the invention are explained in the following figures wherein:

FIG. 1 depicts a conceptual structure of a data model specification representing information which may be required for a railroad ticket.

FIG. 2 depicts an overall view of a preferred embodiment of the object generator of the present invention.

FIG. 3 depicts an aspect of a preferred embodiment of the object generator of the present invention, which relates to generating simple types.

FIG. 4 depicts an aspect of a preferred embodiment of the object generator of the present invention, which relates to generating complex types and arrays.

FIG. 5 depicts an overall view of a preferred embodiment of the serializer of the present invention.

FIG. 6 depicts an overall view of a preferred embodiment of the deserializer of the present invention.

### DETAILED DESCRIPTION

In one aspect, the present invention is a system, apparatus and/or method for communicating between at least one object-oriented program and another program. It is particularly useful when communicating between programs of different languages and/or operating systems. DMS object classes are generated and DMS object instances are translated into and from DMS serial form.

In another aspect, the present invention comprises an object generator that generates the DMS object classes. The object generator according to the invention uses a data model specification to generate an API that defines at least one reflective DMS object class in a target object oriented program (whether as a program in the conventional sense, or as an API, which in turn could include a subroutine, macro, script, library, etc.). As used herein, a “reflective” object class is one that includes a capability of (e.g., a function or procedure for) describing itself to a separate entity (e.g., program), and preferably including the ability of: (1) providing to a serializer program (hereinafter “serializer”) enough information to allow the serializer to translate a DMS object instance into a DMS serial data package (hereinafter “serialize”), and/or (2) providing to a deserializer program (hereinafter “deserializer”) enough information to allow the deserializer to translate a DMS serial data package into a DMS object instance (hereinafter “deserialize”). Unless the context herein indicates the term “translate” may include either serialization or deserialization, or both. Preferably, the serializer and/or deserializer (hereinafter collectively the “formatter”) is separate from the DMS object class. In one embodiment, the reflective information provided to the formatter includes the name(s), data type(s), value(s), and relation(s) of a data instance. Such reflection allows a formatter, without having to be part of the object class, to translate between an object instance and data interchange format. It also allows the formatter to be changed (i.e., modified or substituted) without altering the object class. The ability to change the formatter in turn provides significant flexibility to support new or additional data interchange formats, without requiring modification of the DMS object classes. In addition, significant efficiencies are achieved in the size and structure of the generated DMS object classes, particularly as compared to creating multiple functions in each class, or multiple object classes, for enabling formatting into and from more that one data interchange format.

A DMS object instance according to the present invention is serialized at run-time and a DMS serial data package is deserialized at run-time. Thus, the formatter itself is typically executed by a program that uses the data instance at run-time. The step for executing the program which in turn executes the formatter is typically a program call directly to the formatter that accomplishes the formatter functions set forth herein, although indirect calls are also possible, e.g., by way of proxy. In view of the present disclosure, all of this readily can be implemented by one of ordinary skill in the art, such as by means of a computer having appropriate memory and processor, and programmed with the necessary code to carry out the steps for executing the program which in turn executes the formatter. These are just a few examples of possible steps and/or means for executing the program which in turn executes the formatter. While such illustrative examples are provided herein, it is envisioned that there are a broad range of equivalent steps and/or means that could be used.

In another aspect, the present invention is at least one serializer capable of translating a DMS object instance into a DMS serial data package, and/or at least one deserializer capable of translating a DMS serial data package into a DMS object instance. Preferably the system of the present invention includes both a serializer and deserializer. However, it is recognized that there may be applications wherein only one or the other may be required and therefore it is not necessarily a limitation of the present invention that both be provided. Also, although generally described herein as two separate formatters, it is envisioned that one or more serializers and one or more deserializers optionally may be combined into a single formatter.

Preferably, the target object oriented program, the DMS object class, and the formatter are written in the same language. For example, if the target program is C++, the DMS object class is preferably written in C++, and the formatter is preferably written in C++. However, it is envisioned that it may be of value in some circumstances for one or more of the foregoing to be written in another language.

In addition, it is envisioned that one or more of the foregoing may be a compiled program, one that uses an interpreter, or a combination of each.

Although a programmer could devise his own data interchange format to suit the needs of his own programs or computer systems, standard data interchange formats are preferred in connection with the invention because of their common use, due in turn to the common need to communicate between programs or computer systems. Some standard data interchange formats include, but are not limited to, extensible markup language (XML), Tibco Rendezvous and comma separated values (CSV). These data interchange formats generally are standard file or message formats that govern the separation of data within the file, without limiting the data types, parameters, and organization of the data relative to each other. Serial data of virtually any nature may be contained in such standard data interchange formats.

Although a wide variety of data interchange formats may be suitable for use with the present invention, XML is a preferred format. The preference for XML over a number of other data interchange formats is due to widespread familiarity with and use of XML within the programming community. In addition, there are numerous sources of instruction regarding XML, and it is fairly descriptive, flexible and easy to master.

While XML is preferred for the aforementioned reasons, it is understood that the present invention is not limited to the use of XML, but instead can be used with a variety of data interchange formats, as described above. For example, while XML is a particularly helpful format for exchanging data between one sender and one receiver program, Tibco Rendezvous is particularly helpful when there are many senders/publishers and/or receivers/subscribers. Likewise, while XML, Tibco Rendezvous and comma separated values (CSV) have been identified as examples of data interchange formats, one of ordinary skill in the art will appreciate that other data interchange formats, whether or not they presently exist, may also be included without departing from the present invention. Moreover, there is no requirement that the data package be contained in a message that is transmitted and received. For example, a formatter may be configured to deposit the serialized data directly into a common memory storage location, database or stationary document. These and other variations may be made without departing from the scope of the present invention.

In one embodiment, the present invention may be used with any number of data model specifications, including but not limited to DTD, XML Schema, and database definition language (DDL). In a most preferred embodiment, the data model specification is XML Schema. This is most preferred due to a now widespread familiarity with XML Schema within the programming community, because it is now an internationally recognized standard (governed by the World Wide Web Consortium (W3C)), and because XML Schema provides the ability to specify constraints for data types and inheritance in addition to name(s), value(s), and relation(s). The present invention has the advantage of allowing the programmer to apply the structural constraints of the schema directly into the target program's object class structure or tree.

It also should be noted that the preference for XML Schema is independent of the preference for XML as a data interchange format. Indeed, the use of XML Schema does not require the use of XML data interchange format, and vice versa. In other words, the invention is not limited to any use of XML or XML Schema, and these two need not be used in combination. However, similar reasons support the preference for each. Specifically, methods for creating XML Schema are widely known, there are numerous tools for creating XML Schema, and it is not difficult to learn how to create new XML Schema and/or post new schema to a publicly available repository.

As noted above, there are public and private repositories for distributing and standardizing particular XML Schema(s), and some of these repositories are specific to substantive subject-matter such as business, financial services or science. For example, there are certain repositories with convenient XML Schema which include financial services variables such as account number, account balance, account type, transfer amount, and/or various other related data. One such repository is provided by HR-XML Consortium currently located at www.hr-xml.org/channels/home.htm.

The use of data model specifications in the present invention offers the additional potential benefit of using domain syntax in the DMS object classes and/or DMS serial data packages, which facilitates identification of the DMS object classes, their contents and/or their functions, and allows for more a natural or substance-oriented programming experience. The term “domain syntax” here means the use of terms relating to the substantive nature of the information of concern, such as business, science, etc. In the case of business, for example, domain syntax is exemplified by such terms as “trade,” “account number,” “account balance,” etc.

For example, a foreign investment bank might select a business-related schema that is appropriate to convey certain account information to a domestic bank. Due to the domain syntax, it might be possible for domestic bank analysts with a little training to understand the substantive information provided, and advise the domestic bank's programmer what generally needs to be done with the information, i.e., the goals. The domestic bank programmer would then simply process the schema in the object generator, which in turn would automatically create DMS object classes and permit serialization and deserialization of data so that the target program could communicate with the foreign investment bank's system. This way, the programmer could simply and immediately focus on writing the operative code in his native programming language of choice to accomplish the goals set out by the domestic bank analysts.

The invention also potentially relieves the programmer from the need to keep track of “context” within a serial data package, i.e., where in the data package a particular item of data is located. A ZIP code, for example, could be located at the beginning, the end, or anywhere in the middle of the DMS serial data package. The location would be irrelevant to the programmer using the present invention because the object generator would interpret the model specification or schema to provide a DMS object class capable of being serialized and deserialized, with no context or locational information required from the programmer.

Thus, in one embodiment the tool of the present invention permits the use of domain-syntax. This permits a more substantive information-centric approach as opposed to a programmatic syntax or data interchange format-driven approach to programming. In other words, this allows programmers to deal more with the substantive nature of the information being processed, as opposed to the syntactical and formatting aspects of the data.

In one aspect, the present invention is an object generator capable of compiling a data model specification such as XML Schema into code (e.g., a programmer-friendly API) that defines at least one DMS object class, which permits serialization and/or deserialization of a corresponding object instance. The object generator which generates the DMS object class is at least one executable program. The executable program itself may be created using any of a variety programming languages. In addition, it may be a compiled program or it may be a program that uses an interpreter, or a hybrid. Typically, a compiled program is faster. However, programs written in languages such as Visual Basic or Java, which use interpreters at least to some extent, may also have advantages. In a preferred embodiment, the object generator of the present invention is written in Java because of its good adaptability to different platforms, e.g., UNIX and Windows.

One skilled in the art will appreciate that there are several ways to configure the object generator to input data model specifications. For example, the object generator may be configured to take as input a schema that defines multiple elements/classes in a single file and process it batch-wise in order to generate multiple DMS object classes in one execution. Alternatively, the object generator may be configured to take as input and process a schema that includes only one element/class. Or the generator may also be configured such that the programmer simply provides the name and/or location of one or more schema, or a schema repository, and the object generator retrieves and processes the schemas and/or repository automatically. Or the generator could be configured to allow a programmer to browse through a repository and select particular one or more element/class definitions, which the generator in turn would process automatically. In view of the present disclosure, all of this readily can be implemented by one of ordinary skill in the art, such as by means of a computer having appropriate memory and processor, and programmed with the necessary code. These are just a few illustrative examples of possible steps and/or means for providing a data model specification to an object generator. However, it is envisioned that there are a broad range of equivalent steps and/or means that could be used.

Using model specifications such as XML Schema as input, the object generator of the present invention generates, i.e., effectively compiles or “writes,” DMS object classes which contain the code necessary to define respective object classes in a target object oriented program. In addition, the object generator writes the code necessary to allow the DMS object classes to self-reflect, i.e., code that allows the generated DMS object classes to describe themselves sufficiently so that the formatter written for that target program language can serialize and/or deserialize the respective DMS object instances.

Thus, in a preferred embodiment, the object generator writes a DMS object class to include a built-in capacity for self reflection, so that the DMS object class sufficiently can “describe itself” to permit a formatter to serialize and/or deserialize a particular object instance. In other words, the self-reflection function provides the formatter with sufficient information about the structure and attributes of the DMS object class to enable the formatter to translate instances between forms (serial versus object). Preferably, the self-reflection function also provides the formatter with the data value(s) of the object instance, which has a benefit of avoiding the necessity of incorporating additional logic into the formatter for each specific object instance, to query its data value(s). It also may describe to the formatter the name(s), data type(s), and relation(s) of an object instance, among other things.

While the object generator is preferably executed to compile at least one data model specification into a corresponding DMS object class prior to run time, e.g., by user execution of a stand-alone program or by a call from another program, the object generator also may be executed to generate the DMS object classes at run-time, e.g., by way of a call from another program. In view of the present disclosure, this readily can be implemented by one of ordinary skill in the art, such as by means of a computer having appropriate memory and processor, and programmed with the necessary code to carry out the steps for executing the object generator. The present disclosure illustrates various possible steps and/or means for executing the object generator to generate code comprising a DMS object class. Thus, it is envisioned that there are a broad range of equivalent steps and/or means that could be used.

The language that is used to create the executable object generator does not limit the language of the target program or the DMS object classes. For example, the executable object generator which generates the DMS object classes may be written in Java to create Java DMS object classes. Alternatively, the object generator may be written in C++ to create Java DMS object classes. Conversely, the object generator may be written in Java to create C++ DMS object classes. Other programming languages also can be used in these examples. One skilled in the art will appreciate that there are numerous options available. In addition, while the target program is typically an object oriented program, it is envisioned that in some cases the target program may be a procedural program, i.e., a non-object oriented program.

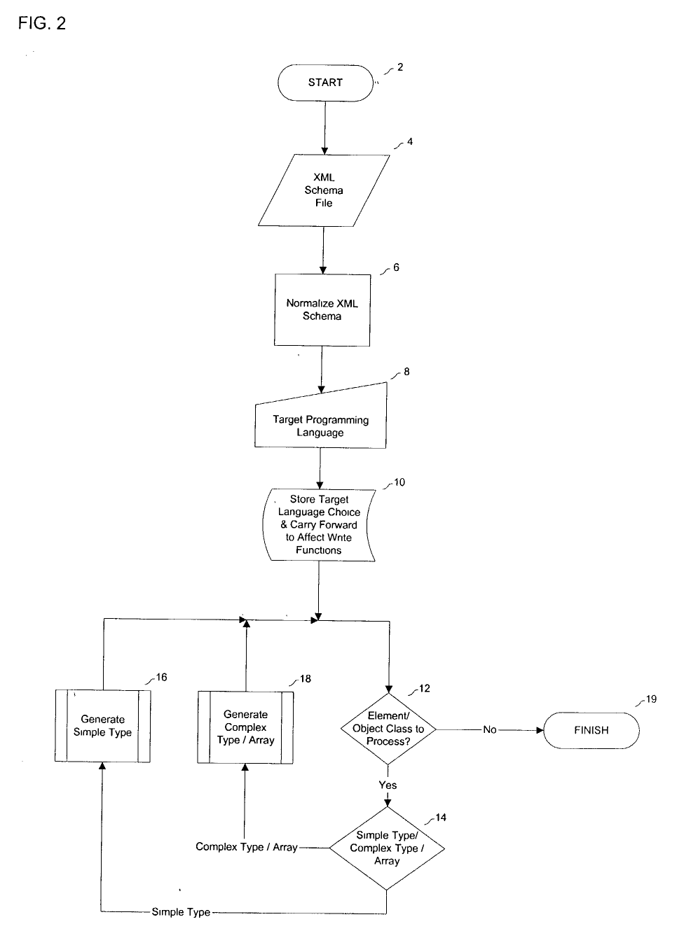

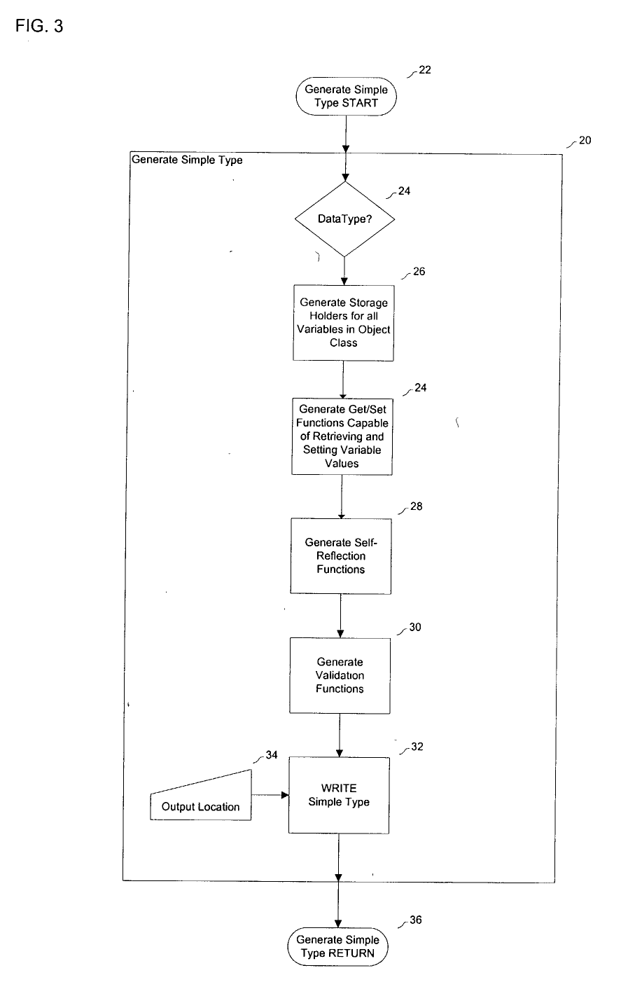

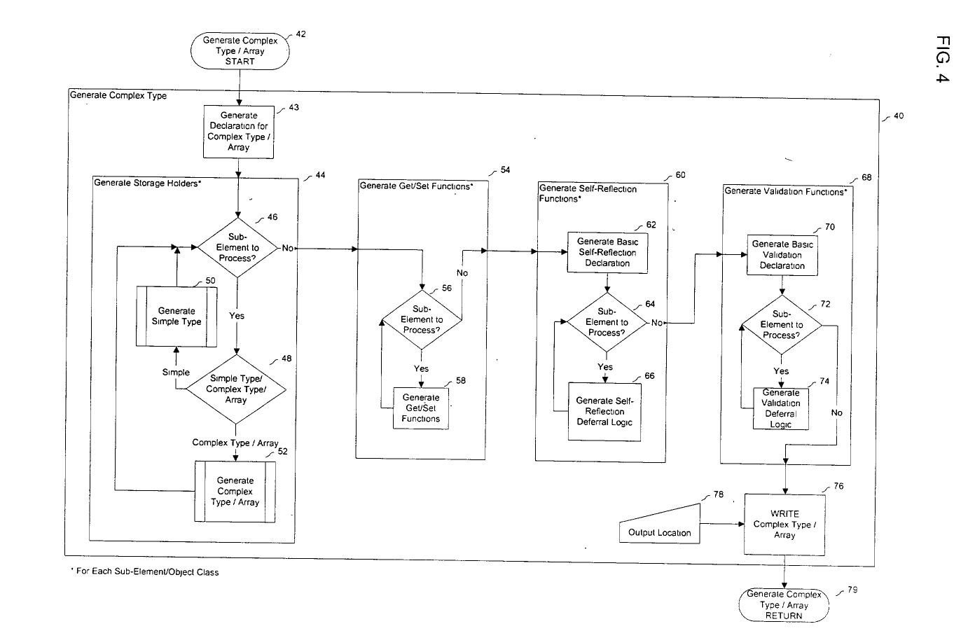

A preferred embodiment of an object generator according to the present invention is depicted in FIG. 2, FIG. 3, and FIG. 4. FIG. 2 depicts an overall view. As depicted in FIG. 2, the object generator is started 2, and an XML Schema file is inputted 4. Because there are various ways to represent equivalent data models in XML Schema, the schema is normalized 6 to provide a internally standardized representation of the data model. The target programming language is determined 8 and carried forward to affect write functions 10. A determination 12 is made whether there is a data model specification element to process. If so, then another determination 14, is made whether it is a simple type, a complex type, or an array. If it is a simple type, then a routine for generating simple types is performed 16. Otherwise, a routine for generating complex types or arrays is performed 18. In either case, after the routine is performed, control reverts back for a determination 12 of whether there is another data model specification element to process. If so, then step 14 etc. is repeated. If not, the object generator is then finished.

FIG. 3 depicts a preferred embodiment of a routine for generating simple types 20, which may be used as the routine 16 in FIG. 2. As depicted in FIG. 3, the routine is started 22, and a determination of the data type is made 24. Storage holders for all variables in the object class are generated 26. Get/set functions capable of retrieving and setting variable values are generated 24. Self-reflection functions are generated 28, i.e., indications of types, values, etc., and validation functions are generated 30. The simple type is written to an API or some other determined location 32, 34. The routine for generating simple types is then finished 36, and control is returned.

FIG. 4 depicts a preferred embodiment of a routine for generating complex types or arrays 40, which may be used as the routine 18 in FIG. 2. As depicted in FIG. 4, the routine is started 42, and a declaration for a complex type or array is generated 43. Four subroutines are then performed. For each sub-data model specification element, storage holders are generated 44, get/set functions are generated 54, self-reflection functions are generated 60, and validation functions are generated 68.

In the storage holder generating step 44, a determination is made whether there is a sub-element to process 46. If not, then control is transferred to the get/set function generating step 54. If so, a determination is made whether it is a simple type, a complex type, or an array 48. If it is a simple type, then a routine 50 is executed, such as the routine 20 depicted in FIG. 3. If it is a complex type or an array, then a routine 52 is executed, such as the routine 40 depicted in FIG. 4. Control reverts back to step 46 for a determination of whether there is another sub-element to process.

In the get/set function generating step 54, a determination 56 is made whether there is a sub-element to process. If not, then control is transferred to the self-reflection generating step 60. If so, then get/set functions are generated 58. Control reverts back to step 56 for a determination of whether there is another sub-element to process.

In the self-reflection generating step 62, a basic self-reflection declaration is generated 62. A determination is made whether there is a sub-element to process 64. If not, then control is transferred to the write step 76. If so, then validation deferral logic is generated 74. By deferring logic regarding types, class relationships, class ordering, array structure, etc., to individual child elements, generating step 62 inherently creates the logic to represent the data model specification, thereby providing for a properly ordered representation of complex classes with a number of simple classes. Control reverts back to step 72 for a determination of whether there is another sub-element to process.

The complex type or array is written to an API or some other determined location 76, 78. The complex type and array generating routine is then finished, and control is returned to the point in the program from which it was called.

This process generates an object class that is self-reflective and is structured so that its components, e.g., name(s), data type(s), value(s), and relation(s), correspond to those specified by the data model specification. Thus, it is a DMS object class. In view of the present disclosure, this process readily can be implemented by one of ordinary skill in the art, such as by means of a computer having appropriate memory and processor, and programmed with the necessary code to carry out the steps for generating code comprising a DMS object class. The present disclosure illustrates various possible variations on these steps and/or means for generating code comprising a DMS object class, which would be within the scope of the invention. Thus, it is envisioned that there are a broad range of equivalent steps and/or means that could be used.

As noted above, the object generator uses a data model specification to generate an API that defines at least one reflective DMS object class in a target object oriented program. The reflective ability which enables the DMS object class to describe itself in-turn allows a formatter separate from the DMS object class to be used. This contributes to the flexibility and efficiency with which the present invention can handle more than one data interchange format.

On the other hand, it is envisioned that multiple formatters may be combined with each other, or kept separate. Thus, for two data interchange formats, there might easily be four programs—one serializer for XML, one deserializer for XML, one serializer for Tibco Rendezvous, and one deserializer for Tibco Rendezvous. Alternatively, all of these four formatters may be combined into a single formatter. Based on the foregoing, one can appreciate that a number of combinations and variations are within the scope of the present invention.

One benefit of the formatter(s) is the potential of allowing a programmer to avoid having to use or even learn about the originating program's variable syntax or the data interchange syntax. The “originating program's variable syntax” as used herein refers to the syntax of variables in the originating program, and “data interchange syntax” means the syntax of the data interchange format used for the serial message or document containing the data package. In the case of XML data interchange format, the data interchange syntax includes for example terms such as “open tag,” “close tag,” etc. With the present invention's formatter, the programmer does not necessarily need to be aware of the originating program's variable syntax or the data interchange syntax. The object generator would automatically write DMS object classes that reflect the particular variables, and permit automatic serialization into and deserialization from the appropriate data interchange syntax.

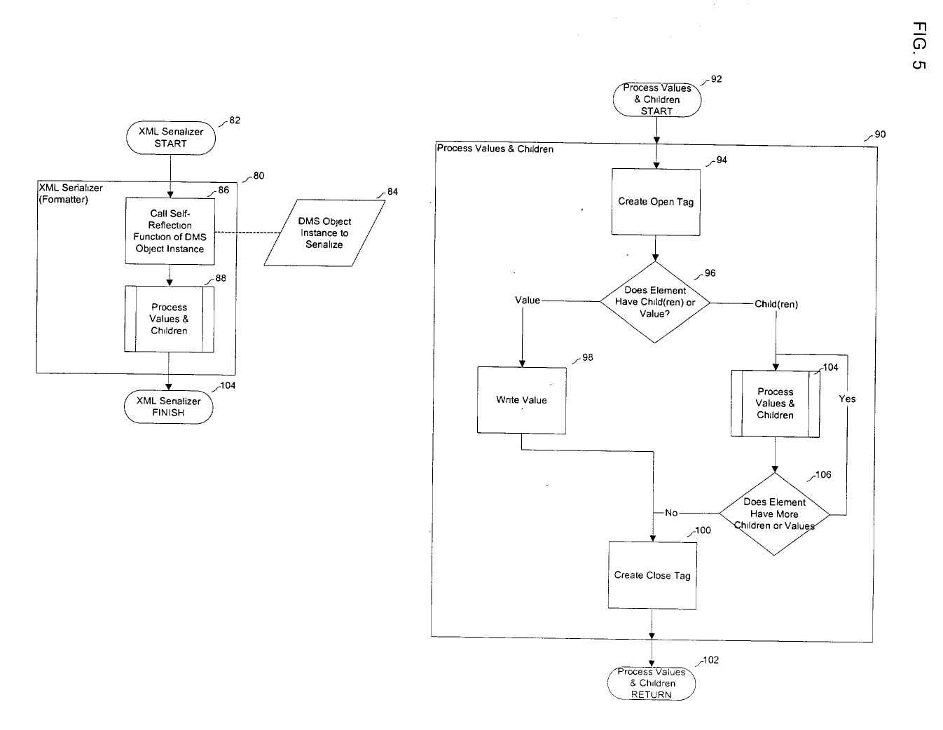

In a preferred embodiment, the formatter is an XML serializer according to FIG. 5. According to this embodiment, the serializer 80 is started 82 and a self-reflection function of a DMS object instance 84 is called 86. A routine for checking the children of the object instance is executed 88. In this example, routine 90 is started 92 and an “open tag” is created 94. A determination 96 is made whether the element has child(ren) or a value. If it has a value, then the value is written 98, and a “close tag” is created 100. Control is then returned 102 to the point from which the routine 90 was called. If the element has child(ren), on the other hand, then routine 90 is executed 104 for the child(ren), and nested looping may occur as result, similar to the nested looping in the processes described above. When control is returned from the routine 90, it is determined whether the element has any more children and, if so, then routine 90 is executed 104 for those children. If not, then a close tag is written and control is returned to the point at which the routine 90 was called.

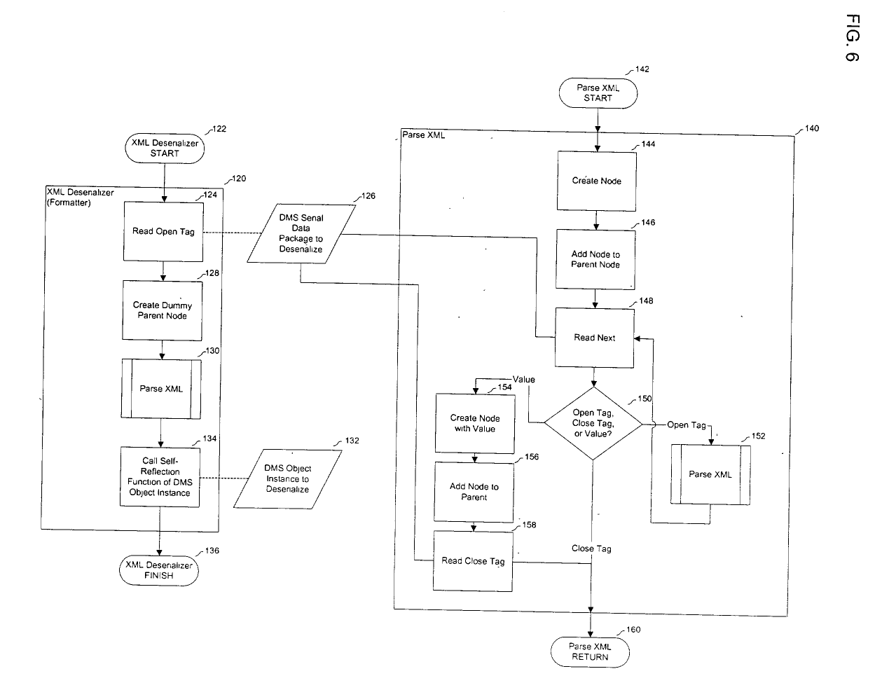

In a preferred embodiment, the formatter is an XML deserializer according to FIG. 6. According to this embodiment, the serializer 120 is started 122 and an “open tag” is read 124 from the DMS serial data package 126 to be deserialized. A dummy parent node is then created 128, and a routine for parsing the XML instance is executed 130. The self-reflection function of the DMS object instance 132 to be deserialized is called 134, taking the results from parsing the XML and passing it to the DMS object instance. The DMS object instance takes the results and inserts the child objects and values it into the object tree. Then, the XML deserializer is finished 136. According to this embodiment, the routine 140 for parsing the XML is started 142 and a node is created 144. The node is added 146 to the parent node. Then, the next item is read 148 and is determined 150 to be either an open tag, a close tag, or a value. If it is an open tag, then the routine for parsing 140 is executed 152 (again resulting in a nested loop). If, on the other hand, the next item is a value, then a node is created 154 with the value. The node is added 156 to the parent and the close tag for the value is read 158. The routine is then finished and control is returned 160 to the point at which the routine was called. Finally, if the next item is a “close tag,” then is likewise returned 160 to the point at which the routine was called.

As with many other object classes, a DMS object class according to the present invention preferably includes a read function and a write function. However, in a most preferred aspect a DMS object class also includes a validate function.

More specifically, in addition to defining an object class, the object generator preferably also writes code necessary to allow the DMS object class to validate data incoming to or outgoing from the object instance. The DMS object class may thereby validate data either as serial data incoming to an object instance or as data outgoing from an object instance to a DMS serial data package.

In addition, such a DMS object class generated to include a validation function is preferably able to implement both structural and content validation rules. By “structural validation rules,” it is meant for example the ability to determine whether anything is missing or extra in a serial or object data instance, regardless of whether the data is incoming or outgoing. By “content validation rules,” it is meant the ability to ascertain for example whether particular data is out of range, incorrect type, or incorrect format. There are numerous situations where such validation functions would be helpful. For example, some data such as ZIP codes must be integers having a particular number of digits. Other data such as addresses may be character-based having variable length. The validation function of the DMS object classes preferably would check to ensure that these rules are followed. Again, it is envisioned that these rules could be applied regardless of whether the data is incoming or outgoing.

In one embodiment, the object generator is capable of generating DMS object classes which decouple validation from serialization and/or deserialization. For example, a class may conduct validation of serial data from a DMS serial data package prior to and separate from the deserializer parsing the data into an object instance. Alternatively, the deserializer might first parse the data without regard to whether the serial data is complete or in conformity with all data types, and then the DMS object class might simply flag in a subsequent validation step what is incomplete or incorrect. In this latter case, it might be the job of a person or program to analyze the flagged object instance and fill in the incomplete variables. It should be noted that the latter sequence could lead to errors if object instance simply cannot accommodate the data. For example, an object instance may not be able to accommodate data in the case of a type mismatch, such that the program would generate an error before reaching the step of validation. One of ordinary skill in the art will appreciate that variations in these sequences may be made without affecting the end result.

In any event, in this embodiment the DMS object class allows the programmer to avoid codifying schema-specified validation rules by hand. It also allows the programmer to avoid running validation programs that are separate from the target program. This is beneficial because the use of separate programs creates a dependency, i.e., the separate program needs to be present and properly configured in order for it to be used by the calling program.

It is also envisioned that the present invention also may allow generation of classes which inherit from each other, for example, from a direct mapping to inheritance/polymorphism in XML Schema. In the case of inheritance, which may apply to complex types, the object generator may also generate additional “class factories” (e.g., virtual constructors) that are used by the programmer to create instances of object classes derived from a base DMS object class (“derived DMS object classes”), by means of some form of identification (e.g., string identifier or tag). Those concrete classes are used in place of the base DMS object class.

In the case of namespaces (i.e., packages), which may provide an additional level of encapsulation, additional declarations may be made to group a namespace of one or more elements together, or to group one or more of such namespaces together.

Some of the embodiments described above can be further understood in the context of the following non-limiting examples.

### EXAMPLES

### Example 1

Object Generation in C++

A schema created to contain the name and age of an individual might have the following conceptual structure:

Msg

| | |
|---|---|
| Name: | string |
| Age: | integer |

An example of XML Schema for this conceptual structure is provided in Table 2, wherein the reference to the XML namespace “xmlns” is mainly to ensure compatibility with future generations of the schema. The schema contains the name and age for an individual.

TABLE 2

<schema xmlns=http://www w3.org/2001/XML Schema>

<element name=“Msg”>

<complexType>

<element name=“Name” type=“string”/>
<element name=“Age” type=“integer”/>

</complexType>

</element>

</schema>

For this schema, the object generator of the present invention would generate source code in the programming language of choice, which in this example is C++. The code might, for example, define the C++ DMS object class shown in the files entitled “Msg.cpp” and “Msg.hpp” in the Computer Program Listing Appendix included herein on compact disc. This object has elements (name, age) that correspond to their respective data types (string, integer). A programmer could dynamically translate data between serial and object form by a run-time C++ call to the formatter.

The DMS object class of the Computer Program Listing Appendix includes code for self-reflection and for validation of object or serial data. The DMS object class of the Computer Program Listing Appendix would be incorporated into a C++ program created by the programmer. The part of the program created by the programmer, on the other hand, might appear as shown in Table 3, which is an example of that part of the C++ program which calls the serializer to translate the C++ object instance into XML format complying with the XML Schema used to generate the DMS object class. Conversely, Table 4 shows an example of a C++ program taking XML serial data and translating it into an C++ object instance. In these two examples, the serializer and deserializer are both part of a single formatter.

TABLE 3

| | |
|---|---|
| Msg m = Msg::Construct( ); | |
| m−>setName(Msg::Name::Construct(“Tim”)); | |
| m−>setAge(Msg::Age::Construct(30)); | |
| XMLFormatter xml; | This is where the programmer specifies that “xml” |
| | causes a call to the formatter which serializes to and |
| | deserializes from XML. |
| stringX = xml.serialize(m); | Here, the programmer actually executes “xml” to call |
| | the serializer to convert the populated C++ object |
| | instance “m” into stringX in XML data format. |
| m−>getName( ); | |
| m−>getAge( ); | |

TABLE 4

| | |
|---|---|
| Msg m = Msg::Construct( ); | |
| XMLFormatter xml; | This is where the programmer specifies that “xml” |
| | causes a call to the formatter which serializes to and |
| | deserializes from XML. |
| xml.deserialize(stringX,m); | Here, the programmer actually executes “xml” to call |
| | the deserializer to convert the stringX XML serial data |
| | package into a C++ object “m” having “Msg” as its |
| | object class. |
| m−>getName( ); | |
| m−>getAge( ); | |

As described above, the DMS object class in the Computer Program Listing Appendix checks to make sure that the data fits the criteria of the data model specification (here, XML Schema). For example, a particular schema might have the criteria that age can be no higher than 30. Applying this to the example of Table 4 as described above, at the option of the programmer, data being deserialized from XML to C++ might be checked automatically to ensure that the object is not erroneously populated with an age datum greater than 30. Conversely, using the example of Table 3 as described above, data being serialized from C++ to XML might be checked automatically to ensure that the XML serial data package will not be populated with an age datum greater than 30. Thus, this optional checking feature works for both sending and receiving. Validation of the DMS serial data package also may entail structural validation, to ensure that the required fields are present, in addition to content and type validation, to ensure that individual fields meet those restrictions.

### Example 2

Object Generation in Java

As described above, the object generator of the present invention can also generate Java DMS object classes. The object generator might, for example, define the Java DMS object class shown in the Computer Program Listing Appendix. The Java DMS object class shown in the file entitled “Msg.java” in the Computer Program Listing Appendix included herein on compact disc is analogous to the C++ DMS object class shown in the files entitled “Msg.cpp” and “Msg.hpp”, and described in Example 1.

### Example 3

DTD

This example demonstrates that other data model specifications may be used in connection with the present invention. Here, DTD is used instead of XML Schema.

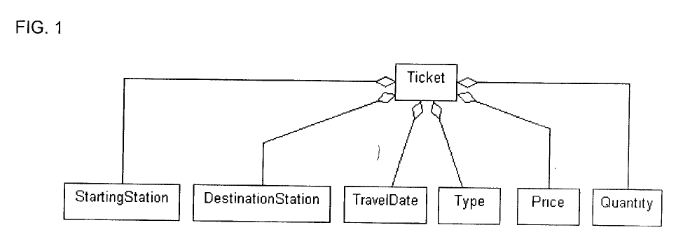

In this example, a DTD data model specification is created to represent the information required for a railroad ticket. The specification might have the conceptual structure shown in FIG. 1, with the elements of Starting Station, Destination Station, Travel Date, Price, and Quantity. For purposes of illustration, a sample XML instance, i.e., a DMS serial data package conforming to this specification is shown in the first column of Table 5. Upon processing the DTD data model specification, the object generator creates a Java DMS object class. For illustrative purposes, a greatly simplified representation showing prophetic sample declarations only is depicted in the second column of Table 5. Here again, the DMS object class might additionally include code for validation of object or serial data.

As can be seen from the Table 6, DTD does not in itself provide for specifying types as does a more sophisticated data model specification like XML Schema. One result is shown in Table 7, which is an example of code that a programmer might write to create a ticket DMS object instance and pass it to a formatter to serialize the object instance to XML. As can be seen from Table 7, data types are defaulted to strings because the DMS object class generated from the DTD data model specification does not have type information, which is one drawback of using DTDs alone. However, this example illustrates that in one embodiment, the present invention is capable of handling DTDs.

TABLE 5

| | |
|---|---|
| XML Instance | Java Class |
| <Ticket> | Public class Ticket { |

| | |
|---|---|
| <StartingStation> | public void set(StartingStation), |

| | |
|---|---|
| Croton-Harmon | public StartingStation getStartingStation( ), |

| | |
|---|---|
| </StartingStation> | public void set(DestinationStation), |
| <DestinationStation>GCT</DestinationStation> | public DestinationStation |
| <TravelDate>Jun. 13, 2002</TravelDate> | getDestinationStation( ); |
| <Type>Day-Return<Type> | -public void set(TravelDate); |
| <Price>$7.50</Price> | public TravelDate getTravelDate( ); |
| <Quantity>1</Quantity> | public void set(Type); |

| | |
|---|---|
| </Ticket> | public Type getType( ); |
| | public void set(Price); |
| | public Price getPrice( ); |
| | public void set(Quantity); |
| | public Quantity getQuantity( ); |

}

TABLE 6

| The DTD: | |
|---|---|
| <!element Ticket (StartingStation, DestinationStation, TravelDate, Price, Quantity)> | |
| <!element StartingStation | (#PCDATA)> |
| <!element DestinationStation | (#PCDATA)> |
| <!element TravelDate | (#PCDATA)> |
| <!element Price | (#PCDATA)> |
| <!element Quantity | (#PCDATA)> |

TABLE 7
Program Code:
XMLFormatter xmlFormatter = new XMLFormatter( );
Ticket ticket = Ticket.construct( );
ticket.set(StartingStation.construct(“Kentish Town”));
ticket.set(DestinationStation.construct(“Blackfriars”));
ticket.set(TravelDate.construct(“Mar. 28, 2002”));
ticket.set(Type.construct(“FirstReturn”));
ticket.set(Price.construct(“23.50”));
ticket.set(Quantity.construct(“1”));
Vector errors = new Vector( );
ticket.validate(errors);
String outputXML = xmlFormatter.serialize(ticket);
System.out.println(“XML = ” + outputXML);
Output:

| | |
|---|---|
| XML = | <Ticket><StartingStation>Kentish Town</StartingStation> |
| | <DestinationStation>Blackfriars</DestinationStation> <TravelDate>Mar. 28, 2002</TravelDate> |
| | <Type>FirstReturn</Type> <Price>23.50</Price> <Quantity>1</Quantity> </Ticket> |

While C++, Java, Visual Basic, and Smalltalk have been identified as examples of programming languages for which the object generator may generate DMS object classes, one of ordinary skill in the art will appreciate that there are numerous other programming languages and that these are also within the scope of the present invention. Also, although XML Schema is perhaps the most well known model specification, those skilled in the art may be familiar with other data model specifications which also may be used within the scope of this invention.

Thus, as described above, the invention provides a method and system for providing interoperability among various object systems. According to a preferred embodiment, the invention is a method which includes providing a data model specification to an object generator, executing the object generator to generate code comprising a DMS object class with at least one self-reflection function, and executing a program which in turn executes a formatter which is separate from the object class, whereby the formatter translates between at least one DMS object instance and at least one DMS serial data package.

In summary, there are numerous embodiments of the present invention. It will be readily appreciated that the embodiments discussed above also include a system, computer executable software code, and/or a programmable computer capable of performing the methods discussed herein.

According to one preferred embodiment, the invention is a system comprising an object-oriented program, an object generator capable of using a data model specification to generate code comprising a DMS object class with at least one self-reflection function, a DMS object class created by the object generator, and a formatter which is separate from the DMS object class and is capable of using information from the self-reflection function to translate between a DMS object instance and a DMS serial data package.

In addition, the invention in one embodiment is computer executable software code. According to this embodiment, the invention is computer executable software code which includes a data model specification, code to use the data model specification to generate code comprising a DMS object class with at least one self-reflection function, code comprising the DMS object class, and code to separate from the DMS object class to translate between a DMS object instance and a DMS serial data package, using information from the self-reflection function.

In addition, in one embodiment the invention according to the invention is a programmed computer. According to this embodiment, the invention is a programmed computer that includes memory having at least one region for storing code and a processor for executing code stored in the memory, wherein the memory is programmed with code comprising a data model specification, the processor is programmed to use the data model specification to generate code comprising a DMS object class with at least one self-reflection function, the memory is programmed with code comprising the DMS object class, and the processor is programmed to separate from the DMS object class to translate between a DMS object instance and a DMS serial data package, using information from the self-reflection function.

The foregoing have all been disclosed herein as examples but not as limitations. The scope of the present invention is defined herein by the claims, which are set forth below.

We claim:

1. A method comprising:
providing a data model specification to an object generator;
executing the object generator to generate code comprising a DMS object class with at least one self-reflection function; and
executing a program which in turn executes a formatter which is separate from the object class, whereby the formatter translates between at least one DMS object instance and at least one DMS serial data package.

2. A method according to claim 1, wherein the formatter comprises a serializer.

3. A method according to claim 1, wherein the formatter comprises a deserializer.

4. A method according to claims 1, wherein the formatter comprises:
a serializer; and
a deserializer, and wherein the serializer and deserializer are separate formatters.

5. A method according to claims 1, wherein the formatter comprises:
a serializer; and
a deserializer, and wherein the serializer and deserializer are a single formatter.

6. A method according to claim 1, wherein executing the program comprises creating from the object class an object instance; and executing the formatter to serialize the DMS object instance into the DMS serial data package, using information from the self-reflection function of the DMS object class.

7. A method according to claim 1, wherein executing the program comprises executing the formatter to deserialize the DMS serial data package into the DMS object instance, using information from the self-reflection function of the DMS object class.

8. A method according to claim 1, wherein the self-reflection function describes to the formatter the name(s), data type(s), value(s), and relation(s) of an object instance.

9. A method according to claim 1, wherein the DMS serial data package is in a data interchange format.

10. A method according to claim 1, wherein the data interchange format is XML.

11. A method according to claim 1, wherein the data interchange format is Tibco Rendezvous.

12. A method according to claim 1, wherein the data interchange format is CSV.

13. A method according to claim 1, wherein the model specification is an XML Schema.

14. A method according to claim 1, wherein the model specification is a DTD.

15. A method according to claim 1, wherein the model specification is a DDL.

16. A method according to claim 1, wherein at least a majority of the program is written in Java.

17. A method according to claim 1, wherein at least a majority of the program is written in C++.

18. A method according to claim 1, wherein at least a majority of the program is written in Visual Basic.

19. A method according to claim 1, wherein at least a majority of the program is written in Smalltalk.

20. A method according to claim 1, wherein the DMS object class contains domain syntax.

21. A method according to claim 1, wherein the DMS serial data package contains domain syntax.

22. A method according to claim 1, further comprising a validation step.

23. A method according to claim 1, wherein the validation comprises structural validation.

24. A method according to claim 1, wherein the validation comprises content validation.

25. A method according to claim 1, wherein the validation comprises structural and content validation.

26. A method according to claim 1, wherein the validation is decoupled from translation.

27. A method according to claim 1, wherein the validation is performed before the translation.

28. A method according to claim 1, wherein the validation is performed after the translation.

29. A method comprising:
a step for providing a data model specification to an object generator;
a step for executing the object generator to generate code comprising a DMS object class with at least one self-reflection function; and
a step for executing a program which in turn executes a formatter which is separate from the object class, whereby the formatter translates between at least one DMS object instance and at least one DMS serial data package.

30. An apparatus comprising:
means for providing a data model specification to an object generator;
means for executing the object generator to generate code comprising a DMS object class with at least one self-reflection function; and
means for executing a program which in turn executes a formatter which is separate from the object class, whereby the formatter translates between at least one DMS object instance and at least one DMS serial data package.

31. A system comprising:
an object-oriented program;
an object generator capable of using a data model specification to generate code comprising a DMS object class with at least one self-reflection function;
a DMS object class created by the object generator; and
a formatter which is separate from the DMS object class and is capable of using information from the self-reflection function to translate between a DMS object instance and a DMS serial data package.

32. Computer executable software code comprising:
code comprising a data model specification;
code to use the data model specification to generate code comprising a DMS object class with at least one self-reflection function;
code comprising the DMS object class; and
code to separate from the DMS object class to translate between a DMS object instance and a DMS serial data package, using information from the self-reflection function.

33. A programmed computer comprising:
a memory having at least one region for storing code; and
a processor for executing code stored in the memory; wherein
the memory is programmed with code comprising a data model specification;
the processor is programmed to use the data model specification to generate code comprising a DMS object class with at least one self-reflection function;
the memory is programmed with code comprising the DMS object class; and
the processor is programmed to separate from the DMS object class to translate between a DMS object instance and a DMS serial data package, using information from the self-reflection function.
